(19) United States
(12) Patent Application Publication
(10) Pub. No.: US 2026/0229165 A1
(43) Pub. Date: Aug. 6, 2026

(54) Drive Control Device, Program, and Display System

(71) Applicants: Sony Group Corporation, Tokyo (JP); Sony Semiconductor Solutions Corporation, Kanagawa (JP)

(72) Inventors: Hisao Sakurai, Saitama (JP); Kengo Matsumoto, Kanagawa (JP); Koji Takamiya, Tokyo (JP); Hirotomo Ema, Fukuoka (JP); Shuma Okazaki, Kanagawa (JP); Miho Yamashita, Kanagawa (JP)

(73) Assignees: Sony Group Corporation, Tokyo (JP); Sony Semiconductor Solutions Corporation, Kanagawa (JP)

(21) Appl. No.: 19/151,434

(22) PCT Filed: Mar. 28, 2024
(86) PCT No.: PCT/JP2024/012722

§ 371 Date: Jul. 28, 2025

(30) Foreign Application Priority Data
Mar. 30, 2023 (JP) 2023-055726

(51) Int. Cl. G09G 3/32; G06F 3/16

(52) U.S. Cl. CPC G09G 3/32; G06F 3/16; G09G 2300/026; G09G 2300/0804; G09G 2310/061; G09G 2310/066; G09G 2310/08; G09G 2320/0242; G09G 2320/064; G09G 2320/0666

(57) ABSTRACT

A drive control device including at least one processor to implement a light emission control unit configured to control raising a frequency of a period in which light emitting diodes (LEDs) of an LED array are turned off.

### TECHNICAL FIELD

The present disclosure relates to a drive control device, a program, and an information processing method of a display system, and particularly, to a drive control device, a program, and a display system capable of suppressing abnormal noise generated in a direct-view light emitting diode (LED) display at a low cost.

### BACKGROUND ART

In recent years, the market for direct-view displays using light emitting diodes (LEDs) has been expanding.

Among these, a tiling type uses a board on which LEDs are mounted (an LED module board: hereinafter also referred to as a module board), but abnormal noise such as “gee” or “beep” may occur in this module board and an internal power supply system.

This phenomenon mainly occurs due to sound generation from multilayer ceramic capacitors (MLCC) installed as bypass capacitors of a power supply line, vibration of coils used in a power supply system, electromagnetic vibration of wires of the board, or the like in a specific period.

Conventionally, with respect to sound generation (generation of abnormal noise) in MLCCs, measures have been taken by adopting low-distortion MLCCs (low-sounding products) or replacing MLCCs with solid capacitors such as tantalum capacitors.

In coils, it is common to suppress vibration through impregnation processing. For electromagnetic vibration of board wires, it is common to take measures such as reducing parallel wiring in a wiring layout.

Furthermore, a technique has been proposed in which a plurality of bypass capacitors are provided to generate vibration having opposite phases, thereby curbing generation of vibration noise (refer to PTL 1).

### CITATION LIST

### Patent Literature

### [PTL 1]

JP 2000-056727A

### SUMMARY OF INVENTION

### Technical Problem

However, in the technique described in PTL 1, a mechanism for actually generating vibration having opposite phases has a very complicated configuration.

In addition, even if a mechanism for generating vibration having opposite phases can be configured, the device configuration will be doubled. In particular, a large number of parts such as bypass capacitors are used, and even if the unit price of each part is low, the cost of the entire set greatly increases.

Furthermore, since tantalum capacitors fail in a short-circuit mode, using a large number of tantalum capacitors may degrade product quality.

The present disclosure has been made in view of such circumstances, and in particular, enables abnormal noise generated in a direct-view light emitting diode (LED) display to be suppressed at a low cost.

### Solution to Problem

A drive control device and a program of a first aspect of the present disclosure are a drive control device and a program including a light emission control unit configured to control raising a frequency of a period in which light emitting diodes (LEDs) of an LED array are turned off.

In the first aspect of the present disclosure, light emission of the light emitting diodes (LEDs) of the LED array is controlled, and the frequency of the period in which the LEDs are turned off is raised.

A display system of a second aspect of the present disclosure is a display system including: a display part including a display having light emitting diodes (LEDs) disposed in the form of an array and a drive control device configured to control driving of the LEDs, and a distribution device configured to: receive input of video signals, perform predetermined signal processing on the video signals, and distribute the video signals to the display, wherein the drive control device includes at least one processor to implement a light emission control unit configured to control raising a frequency of a period in which the LEDs are turned off.

In the second aspect of the present disclosure, input of video signals is received, predetermined signal processing on the video signals is performed, the video signals are distributed to a display, light emission of the light emitting diodes (LEDs) is controlled and the frequency of the period in which the LEDs are turned off is raised.

### BRIEF DESCRIPTION OF DRAWINGS

FIG. 1 is a diagram illustrating a configuration example of a display system of the present disclosure.

FIG. 2 is a diagram illustrating a configuration example of a video wall controller and a display unit in FIG. 1.

FIG. 3 is a diagram illustrating a configuration example of an LED array.

FIG. 4 is a diagram illustrating the principle of generating abnormal noise.

FIG. 5 is a diagram illustrating the principle of generating abnormal noise.

FIG. 6 is a diagram illustrating the principle of generating abnormal noise.

FIG. 7 is a simplified circuit diagram illustrating a circuit configuration of a board.

FIG. 8 is a diagram illustrating distortion of an MLCC.

FIG. 9 is a timing chart illustrating a conventional blanking period.

FIG. 10 is a timing chart illustrating a blanking period of the present disclosure.

FIG. 11 is a timing chart illustrating an emission timing for each row in an LED array.

FIG. 12 is a timing chart illustrating an emission timing for each row in an LED array.

FIG. 13 is a diagram illustrating a method of setting a blanking period.

FIG. 14 is a diagram illustrating effects in a case in which a short blanking period is set.

FIG. 15 is a flowchart illustrating display processing.

FIG. 16 is a flowchart illustrating driver control processing.

FIG. 17 is a diagram illustrating a first application example of suppressing generation of abnormal noise by setting a short scan blanking period.

FIG. 18 is a flowchart illustrating driver control processing in the first application example.

FIG. 19 is a timing chart illustrating an example of increasing a scan frequency to increase a ripple frequency (a frequency at which ripples are generated), thereby making it difficult to recognize generated abnormal noise.

FIG. 20 is timing chart illustrating an example of setting a virtual scan blanking period and increasing a ripple frequency while suppressing a scan frequency to make it difficult to recognize generated abnormal noise as a second application example of the present disclosure.

FIG. 21 is a diagram illustrating details of the example of setting a virtual scan blanking period in FIG. 20.

FIG. 22 is a flowchart illustrating display processing in the second application example.

FIG. 23 is a flowchart illustrating driver control processing in the second application example.

FIG. 24 shows a configuration example of a general-purpose computer.

### DESCRIPTION OF EMBODIMENTS

Preferred embodiments of the present disclosure will be described in detail below with reference to the accompanying drawings. Note that, in this specification and the drawings, components having substantially the same functional configurations are denoted by the same reference numerals and redundant explanation will be omitted.

Hereinafter, forms for implementing the present technology will be described. Description will be given in the following order.
1. Configuration example of display system
2. Detailed configurations of video wall controller and display unit
3. Configuration example of LED array
4. Ripple voltage
5. Principle of generation of abnormal noise
6. Blanking period
7. Setting of length of blanking period
8. Display processing
9. Driver control processing by display unit
10. First application example
11. Driver control processing by display unit in first application example
12. Second application example
13. Display processing in second application example
14. Driver control processing by display unit in second application example
15. Example of execution by software

### 1. Configuration Example of Display System

In particular, the present disclosure makes it possible to suppress abnormal noise generated in a direct-view light emitting diode (LED) display at a low cost.

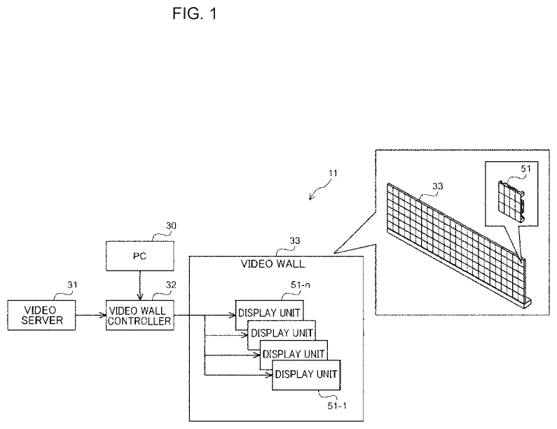

FIG. 1 shows a configuration example of a display system to which the technology of the present disclosure is applied.

The display system 11 of FIG. 1 displays video content on a large display including a plurality of display units disposed in the form of tiles.

More specifically, the display system 11 includes a personal computer (PC) 30, a video server 31, a video wall controller 32, and a video wall 33.

The personal computer (PC) 30 is a general-purpose computer that receives user operation inputs and supplies commands according to operation content to the video wall controller 32.

The video server 31 is composed of, for example, a server computer and the like, and supplies video signal data such as video content to the video wall controller 32.

The video wall controller 32 operates according to commands supplied from the PC 30, distributes data including video signals of video content to display units 51-1 to 51-n that constitute the video wall 33, and causes the display units 51-1 to 51-n to display the data.

In a case in which the display units 51-1 to 51-n need not be individually distinguished, they are simply referred to as a display unit 51.

As shown in the upper right part of FIG. 1, the video wall 33 has display units 51-1 to 51-n disposed in the form of tiles, each of which has LED pixels disposed in the form of an array, and a single image is displayed on the video wall 33 as a whole by combining images displayed by the individual display units 51 in the form of tiles.

The video wall controller 32 performs predetermined signal processing on data including video signals of video content supplied from the video server 31, distributes and supplies the data according to the arrangement of the display units 51-1 to 51-n, and controls individual displays of the display units 51-1 to 51-n such that the video wall 33 displays a single image as a whole.

Note that the video wall controller 32 and the video wall 33 may have an integrated configuration or may be a display device (information processing system) in which they are integrated.

### 2. Detailed Configurations of Video Wall Controller and Display Unit

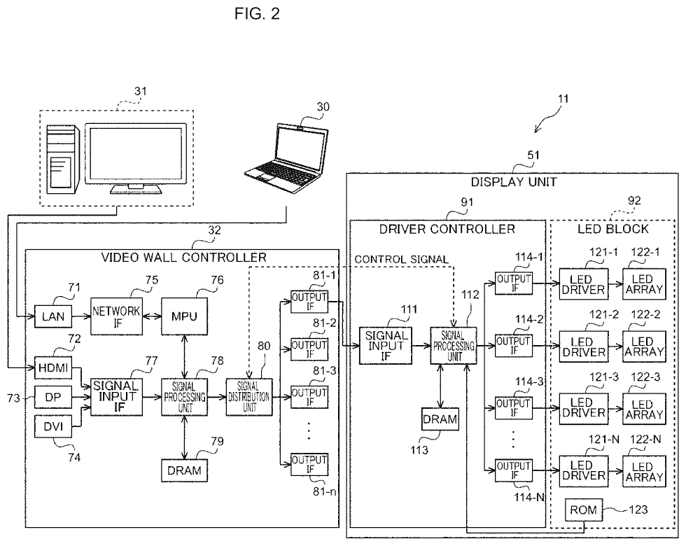

Next, a detailed configuration example of the video wall controller 32 and the display unit 51 will be described with reference to FIG. 2.

The video wall controller 32 includes a local area network (LAN) terminal 71, a High Definition Multimedia Interface (HDMI) (registered trademark) terminal 72, a display port (DP) terminal 73, a digital visual interface (DVI) terminal 74, a network interface (IF) 75, a microprocessor unit (MPU) 76, a signal input IF 77, a signal processing unit 78, a dynamic random access memory (DRAM) 79, a signal distribution unit 80, and output IFs 81-1 to 81-n.

The local area network (LAN) terminal 71 is, for example, a connection terminal such as a LAN cable that is operated by a user and realizes communication with the personal computer (PC) 30 that supplies control commands and the like according to operation content to the video wall controller 32 through a LAN, and supplies an input control command and the like to the MPU 76 through the network IF 75.

The LAN terminal 71 may be configured to be physically connected with a wired LAN cable, or may be configured to be connected by a so-called wireless LAN realized by wireless communication.

The MPU 76 receives input of control commands supplied from the PC 30 via the LAN terminal 71 and the network IF 75 and supplies control signals corresponding to the received control commands to the signal processing unit 78.

The HDMI terminal 72, the DP terminal 73, and the DVI terminal 74 are all input terminals for data including video signals, and they are connected to, for example, a server computer serving as the video server 31, and supply data including video signals to the signal processing unit 78 through the signal input IF 77.

Although FIG. 2 shows an example in which the video server 31 and the HDMI terminal 72 are connected, the HDMI terminal 72, DP terminal 73, and DVI terminal 74 only have different standards and have practically similar functions, and thus any of them is selected and connected as required.

The signal processing unit 78 adjusts the color temperature, contrast, brightness, and the like of data including video signals supplied via the signal input IF 77 on the basis of a control signal supplied from the MPU 76 and supplies the data to the signal distribution unit 80. Here, the signal processing unit 78 expands the data including video signals using the connected DRAM 79, executes signal processing based on the control signal, and supplies a signal processing result to the signal distribution unit 80 as necessary. Further, the signal processing unit 78 supplies various types of information such as a frame rate as a control signal to the signal processing unit 112 of the display unit 51 to which video signals are supplied as information related to display.

The signal distribution unit 80 distributes the data including video signals on which signal processing has been executed, supplied from the signal processing unit 78, and individually distributes and transmits the data to the display units 51-1 to 51-n via the output IFs 81-1 to 81-n.

The display unit 51 includes a driver controller 91 and an LED block 92.

The driver controller 91 supplies data including video signals for controlling light emission of LEDs constituting LED arrays 122-1 to 122-N to a plurality of LED drivers 121-1 to 121-N constituting the LED block 92.

More specifically, the driver controller 91 includes a signal input IF 111, a signal processing unit 112, a DRAM 113, and output IFs 114-1 to 114-N.

The signal input IF 111 receives input of video signal data supplied from the video wall controller 32 and supplies the data to the signal processing unit 112.

The signal processing unit 112 corrects the color and luminance of each display unit 51 on the basis of the video signal data supplied from the signal input IF 111, generates data for setting the emission intensity of each LED constituting the LED arrays 122-1 to 122-N, and distributes and supplies the data to the LED drivers 121-1 to 121-N of the LED block 92 via the output IFs 114-1 to 114-N.

More specifically, the video signal data also includes information such as the length of a blanking period defined by general standards. For this reason, the signal processing unit 112 generates data for setting the number of LED rows (Scan line number), the number of times light is repeatedly emitted within one frame (cycle number), and the emission intensity of each LED constituting the LED arrays 122-1 to 122-N in consideration of the information such as the length of the blanking period included in the video data signal, and distributes and supplies the data to the LED drivers 121-1 to 121-N of the LED block 92 via the output IFs 114-1 to 114-N.

The LED block 92 includes the LED drivers 121-1 to 121-N, the LED arrays 122-1 to 122-N, and a read only memory (ROM) 123.

The LED drivers 121-1 to 121-N performs pulse width modulation (PWM) control of light emission of LEDs disposed in the form of an array which constitute the corresponding LED arrays 122-1 to 122-N on the basis of data for setting the emission intensity of LEDs 141, which is video signals supplied from the driver controller 91.

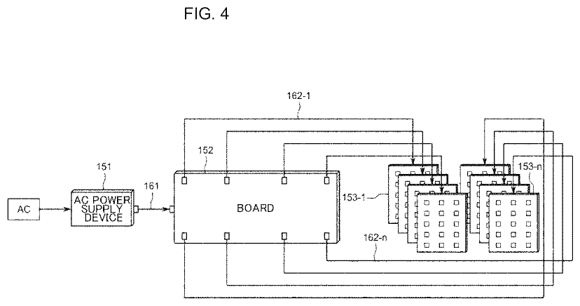

The ROM 123 stores board mounting information such as the type (capacity) and number of capacitors such as MLCCs mounted on a board 153 (FIG. 4) constituting the LED block 92, and the like, and the signal processing unit 112 sets video signal processing by reading the board mounting information from the ROM 123 when power is applied. More specifically, the signal processing unit 112 sets a length of a blanking period shorter than the blanking period defined by general standards on the basis of the board mounting information read from the ROM 123 when power is applied. Details of setting the blanking period will be described later.

### 3. Configuration Example of LED Array

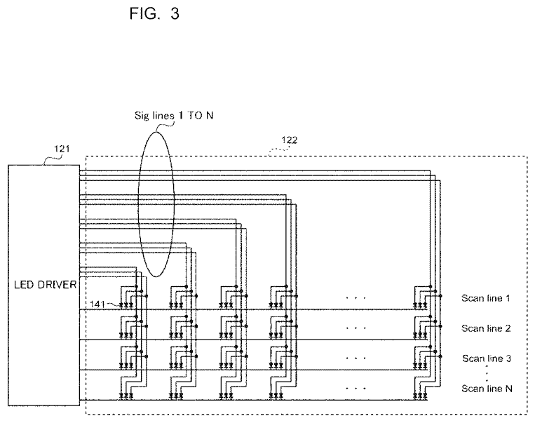

Next, a configuration example of the LED array 122 will be described with reference to FIG. 3. FIG. 3 shows a configuration example of the LED array 122 in a passive matrix drive type LED drive connection. Accordingly, light emission of the LEDs 141 of the LED array 122 is controlled using a passive matrix drive method.

In the LED array 122 of FIG. 3, common cathode type LEDs 141 are disposed in the form of an array, and each LED 141 is connected to a Sig line (luminance control wire) wired in the vertical direction and a Scan line (row selection wire) wired in the horizontal direction.

In the LED array 122 of FIG. 3, when Scan line 1 is turned on by being set to a predetermined fixed potential, current is supplied from the Sig lines to the LEDs, causing light emission. Note that the predetermined fixed potential is generally GND=0 V potential, but is not limited thereto.

### 4. Ripple Voltage

Next, a ripple voltage that causes abnormal noise will be described with reference to FIGS. 4 to 7. First, a power supply configuration for supplying power to the display units 51-1 to 51-n will be described.

FIG. 4 shows an overview of the power supply configuration for supplying power to the display units 51-1 to 51-n.

The power supply configuration of FIG. 4 includes an AC power supply device 151 that receives an alternating current (AC) power supply input and supplies power to the subsequent stage, and a board/wiring (board on which wires are formed) 152 on which various circuits, wiring, and the like constituting the video wall controller 32 are provided, and boards/wiring (on which wires are formed) 153-1 to 153-n on which various circuits, wiring, and the like constituting each of the display units 51-1 to 51-n constituting the video wall 33 are provided.

Further, the AC power supply device 151 and the board 152 are electrically connected via a wire 161, and the board 152 and the boards 153-1 to 153-n are electrically connected via wires 162-1 to 162-n.

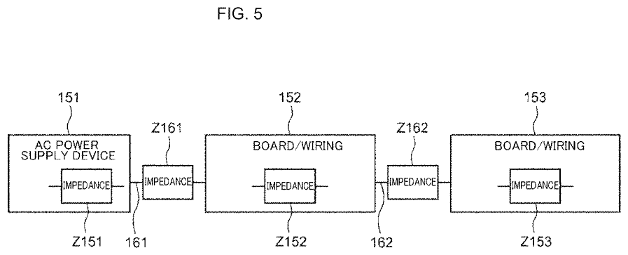

As shown in FIG. 5, the AC power supply device 151, the boards 152 and 153, and the wires 161 and 162-1 to 162-n have internal impedances Z151, Z152, Z153, Z161, and Z162, respectively.

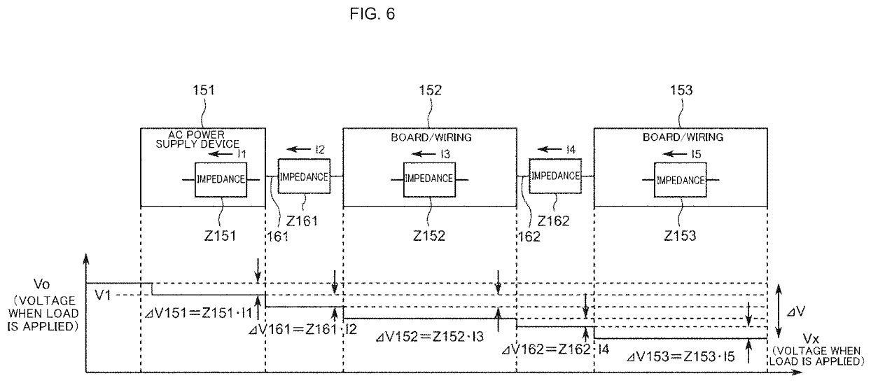

Therefore, as shown in FIG. 6, if it is assumed that the AC power supply device 151 receives an AC power input of voltage V0 when no load is applied, the output voltage of the AC power supply device 151 will be dropped by a voltage ΔV151 (=Z151×I1 (written as Z151·I1 in the figure, and the same applies hereafter)) corresponding to the impedance Z151 if the internal current is the current I1 for the voltage V0.

Further, similarly in the wire 161, if the internal current is a current I2, a voltage drop occurs by a voltage Δ161 (=Z161×I1) corresponding to the impedance Z161.

Furthermore, similarly in the board 152, if the internal current is a current I3, a voltage drop occurs by a voltage Δ152 (=Z152×I3) corresponding to the impedance Z152.

Further, similarly in the wire 162, if the internal current is a current I4, a voltage drop occurs by a voltage Δ162 (=Z162×I4) corresponding to the impedance Z162.

Furthermore, similarly in the board 153, if the internal current is a current I5, a voltage drop occurs by a voltage Δ153 (=Z153×I5) corresponding to the impedance Z153.

As a result, voltage drop occurs by a voltage ΔV (=ΔV151+ΔV161+ΔV152+ΔV162+ΔV153) of all of the AC power supply device 151, the boards 152 and 153, and the wires 161 and 162, which is a difference between the voltage V0 of the power supplied from the AC power supply device 151 and a voltage Vx applied to the board 153.

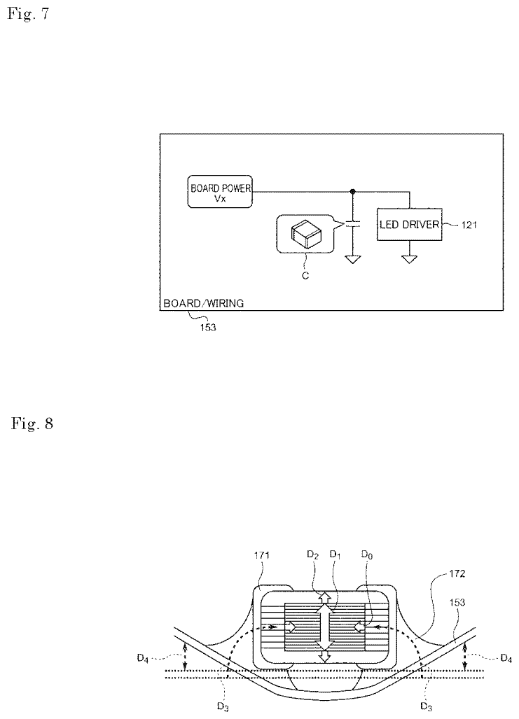

Further, when the circuit configuration formed on the board 153 is expressed in a simple circuit diagram, as shown in FIG. 7, the circuit configuration can be regarded as a circuit in which the LED driver 121 provided on the board 153 and a capacitance C such as an MLCC are connected in parallel.

Therefore, in a case in which the LEDs 141 are emitting light, a current flows through the LED driver 121 and the MLCC, that is, a load is applied, and the voltage Vx generated by voltage drop from a power supply voltage V1 by the voltage ΔV is applied to the LED driver 121.

On the other hand, in a case in which the LEDs 141 are turned off, the current of the LED driver 121 and MLCC are reduced, resulting in a no-load state, and thus voltage drop corresponding to the voltage ΔV does not occur and the voltage V1 is applied to the LED driver 121.

That is, depending on whether the voltage drop of the voltage ΔV occurs in response to the light emitting state of the LEDs 141, the voltage applied to the LED driver 121 and the MLCC changes between the voltages V0 and Vx. Here, the voltage ΔV corresponding to voltage drop that appears to be a rectangular wave due to change from the voltage Vx in the loaded state to the voltage V0 when the state temporarily becomes a no-load state is a ripple voltage ΔV. This ripple voltage ΔV causes abnormal noise. The principle of generation of abnormal noise due to the ripple voltage ΔV will be described later.

### 5. Principle of Generation of Abnormal Noise

Next, in description of the principle of generation of abnormal noise due to the ripple voltage ΔV, voltage distortion caused by an MLCC mounted on the board 153 will be described. Here, the board 153 will be described as an example, but the same applies to the board 152 as well.

FIG. 8 is a side cross-sectional view for describing distortion that occurs when a voltage is applied to an MLCC 171 connected to the board 153 by a connecting part 172 made of solder, adhesive, or the like.

The MLCC 171 has a configuration in which ferroelectrics made of a ceramic material are laminated in the vertical direction in the figure, and when a voltage is applied, it expands as indicated by an arrow D2 in a direction (vertical direction in the figure) parallel to an electric field application direction corresponding to the vertical direction as indicated by an arrow D1 in the figure, and contracts in the direction perpendicular to the arrow D1 indicating the electric field application direction in the figure, as indicated by an arrow DO in the horizontal direction in the figure.

Accordingly, the board 153 is drawn to the side surface of the MLCC 171 through the connecting part 172 that fixes the MLCC 171 on the board 153, as indicated by a dotted arrow D3.

As a result, as indicated by an arrow D4, the board 153 is distorted (deflected) into a shape convex downward in the figure, centering on the portion bonded to the MLCC 171.

That is, as shown in FIG. 8, when the ripple voltage ΔV is generated, a voltage is applied to the MLCC 171 and thus the board 153 is deflected (distorted) as shown in FIG. 8, and when the ripple voltage ΔV is eliminated, no voltage is applied to the MLCC 171 and thus the board 153 returns to a flat state and distortion is eliminated.

As the board 153 changes as described above, such as being distorted or becoming a flat state depending on whether or not the ripple voltage ΔV is generated, abnormal noise is generated from the board 153.

### 6. Blanking Period

Meanwhile, in standards for displaying images on display devices, display images are defined to be displayed at a predetermined frequency in units of frames in order to comply with the standards established during the era of conventional cathode ray tube display devices.

According to this regulation, a blanking period in which no image is displayed between frames, that is, from when the last row of the previous frame is displayed until when the first row of the next frame is displayed, is set.

That is, as shown by the waveform of LED emission timing in the upper part of FIG. 9, a current for causing the LEDs 141 to emit light flows through the LED driver 121 during times t0 to t1, t2 to t3, t4 to t5, and the like which are emission periods of the LEDs 141 during which an image is displayed in units of frames.

In the times t1 to t2, t3 to t4, t5 to t6, and the like which are the blanking periods Tblks between frames, the LEDs 141 are in an off state, and thus the flow of the current for causing the LEDs 141 to emit light becomes substantially zero.

Therefore, the voltage applied to the MLCC 171 changes depending on presence or absence of the current for causing the LEDs 141 to emit light, as shown by the waveform of the power supply voltage in the lower part of FIG. 9, and thus the ripple voltage ΔV as shown by a rectangular wave is generated during the blanking period Tblks.

As a result, in the blanking period Tblks, the voltage applied to the MLCC 171 changes at intervals at which the ripple voltage ΔV is generated, and accordingly, the board 153 is distorted, resulting in abnormal noise.

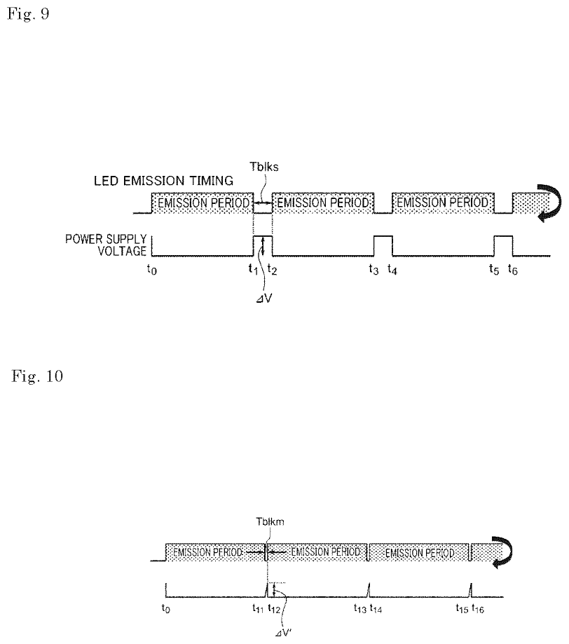

Therefore, in the present disclosure, by setting the blanking period Tblks to a shorter blanking period Tblkm (<Tblks), as shown in FIG. 10, the generated ripple voltage is reduced to a voltage ΔV′ (<ΔV), the voltage applied to the MLCC 171 is reduced to suppress distortion of the board 153 and curb generation of abnormal noise caused thereby.

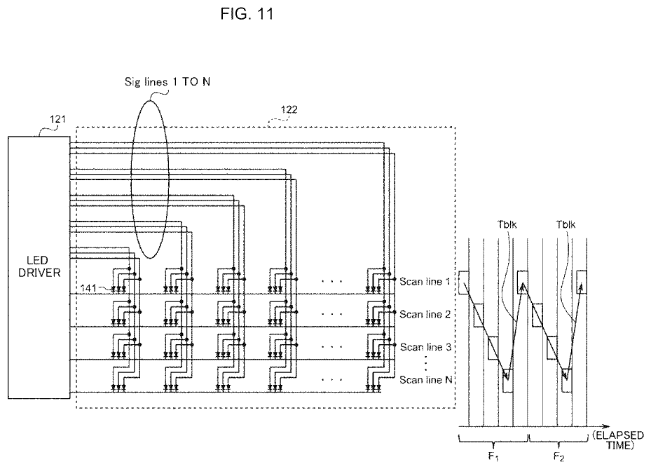

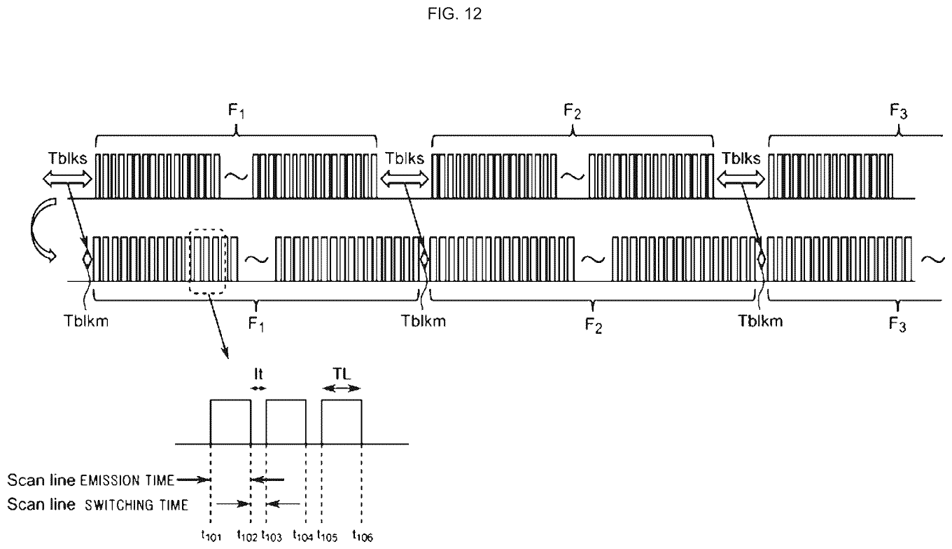

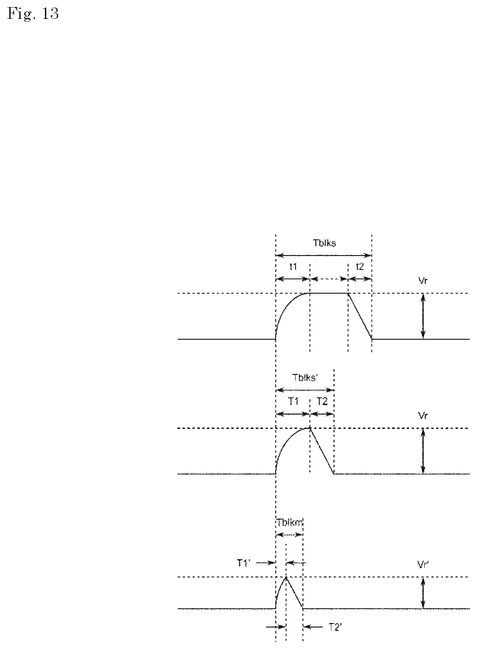

Here, the blanking period will be described in more detail with reference to FIGS. 11 and 12. In FIG. 11, the left part is a configuration diagram of the LED driver 121 and the LED array 122 described with reference to FIG. 3, and the right part shows timing of light emission in units of rows (in units of Scan lines) of LEDs constituting the LED array 122.

That is, as indicated by diagonally downward arrows in the right part of FIG. 11, the LED driver 121 repeats processing for sequentially emitting light from top to bottom, that is, from Scan line 1 to Scan line N, in units of rows for each frame.

Each of rectangular parts penetrated by the diagonally downward arrows in the right part of FIG. 11 represents an emission timing of each row in frames F1, F2, . . . , and shows that LEDs emit light in chronological order in units of rows.

For example, when the emission timing of Scan line N in frame F1 ends, as indicated by a diagonally upward arrow, the position of a row emitting light changes from Scan line N which is the lowest row to Scan line 1 which is the uppermost row in the next frame F2. At this timing, a blanking period Tblk is set.

At this time, the waveforms of currents flowing through the LED driver 121 and MLCC 171 in each frame are represented by waveforms as shown in uppermost and middle parts of FIG. 12. The uppermost part of FIG. 12 is a current waveform for describing the conventional blanking period Tblks and the middle part of FIG. 12 is a current waveform for describing the blanking period Tblkm of the present disclosure.

Here, in each of the frames F1, F2, . . . , as shown in the lower part of FIG. 12, a fine rectangular waveform represents an emission time for each Scan line, the period between the rectangular waveforms represents a switching time between Scan lines, and timing at which no waveform is present between frames F1 and F2 represents the blanking periods Tblks and Tblkm.

That is, in the lower part of FIG. 12, the periods from time t101 to time t102, from t103 to t104, and from t105 to t106 are emission times in units of rows, and the periods from time t102 to time t103, and from t104 to t105 are switching times in units of rows.

As described above, the ripple voltage ΔV is generated due to the fact that the current is approximately zero during the blanking period Tblks.

Therefore, in the present disclosure, by reducing the blanking period Tblks to the blanking period Tblkm (<Tblks), as shown in the middle part of FIG. 12, light emission of the next frame is started until the ripple voltage increases significantly to reduce the generated ripple voltage ΔV, thereby curbing generation of abnormal noise.

### 7. Setting of Length of Blanking Period

Next, setting of the length of the blanking period for reducing the ripple voltage ΔV will be described.

As shown in the uppermost part of FIG. 13, the conventional blanking period Tblks includes a rising period T1 during which the ripple voltage exponentially rises to a voltage Vr, a steady period indicated by a dotted line during which the voltage Vr remains in a steady state, and a falling period T2 during which the voltage linearly drops, and is set to be approximately 5 to 8% of the light emission period of one frame as a whole.

In order to reduce the ripple voltage, it is necessary to shorten the blanking period Tblks, but the magnitude of the ripple voltage Vr does not change even if the steady period is eliminated to set the blanking period Tblks′, for example, as shown in the middle part of FIG. 13, and thus generation of abnormal noise cannot be curbed. However, when the steady period decreases, such as the blanking period Tblks′, the frequency of generated abnormal noise changes, and thus the sound range changes.

In order to reduce the ripple voltage Vr to a ripple voltage Vr′, for example, as shown in the rising period T1′ in the lower part of FIG. 13, it is necessary to set a short blanking period Tblkm such that a falling period T2′ is started, that is, light emission of the next frame is rapidly started, at timing before rising to the ripple voltage Vr.

Here, change in each of the rising period and the falling period of the ripple voltage will be conceived.

A rising voltage Vru of the ripple voltage during the rising period described above can be represented, for example, by the following expression (1).

$$Vru = Vr ( 1 - e ( - T {1}^{′} / τ ) ) \qquad ( 1 )$$

Here, Vru is the ripple voltage during the rising period T1 shown in the upper part of FIG. 13, Vr is the maximum value of the ripple voltage in the steady state, and T1′ is the length of the rising period.

Further, τ is a constant (=R·C) composed of a DC resistance component R and a capacitance C which are main components of the impedance Z of the MLCC 171.

Furthermore, the ripple voltage Vrd during the falling period can be represented, for example, by the following expression (2).

$$Vrd = I \cdot T {2}^{′} / C \qquad ( 2 )$$

Here, I is the current value flowing through LEDs, T2′ is the length of the falling period, and C is the capacitance of the MLCC 171.

When the maximum value of the ripple voltage is set to Vr/n, which is reduced from the conventional voltage Vr by 1/n, the rising period T1′ and the falling period T2′ are obtained by the following expressions (3) and (4).

$$Vru = Vr / n = Vr ( 1 - e ( - T {1}^{′} / τ ) )$$

$$1 / n = 1 - e ( - T {1}^{′} / τ )$$

$$T {1}^{′} = - τ \cdot ln ( 1 - 1 / n ) \qquad ( 3 )$$

$$Vrd = Vr / n = I \cdot T {2}^{′} / C$$

$$T {2}^{′} = Vr \cdot C / ( n \cdot I ) \qquad ( 4 )$$

Therefore, the blanking period Tblkm when set to the voltage Vr/n reduced by 1/n from the voltage Vr which is the maximum value of the conventional ripple voltage can be set as represented by the following expression (5).

$$Tblkm = T {1}^{′} = T {2}^{′}$$

$$= - τ \cdot ln ( 1 - 1 / n ) \cdot C / ( n \cdot I )$$

$$= - R \cdot C \cdot ln ( 1 - 1 / n ) + Vr \cdot C / ( n \cdot I )$$

$$= C ( - R \cdot ln ( 1 - 1 / n ) + Vr / ( n \cdot I ) ) \qquad ( 5 )$$

As described above, the signal processing unit 112 of the driver controller 91 in the display unit 51 reads the board mounting information from the ROM 123 at the time of startup, sets the blanking period Tblkm in this manner on the basis of the read board mounting information, and controls a clock which is not shown used for PWM control of LEDs to control an emission timing of an LED, realizing the blanking period Tblkm.

In setting the blanking period Tblkm, n is set as a parameter included in the above-described expression (5), and the extent to which the ripple voltage is to be reduced is specified.

In addition, since it is possible to minimize the capacitance C of the MLCC 171 by minimizing the blanking period, it is possible to curb generation of abnormal noise and to reduce costs by decreasing the capacity of the MLCC 171.

Furthermore, by increasing the capacitance C of the MLCC 171, it is possible to set the blanking period Tblkm to be longer while curbing generation of abnormal noise.

For example, in a case in which the impedance R of the MLCC 171=40 mΩ, capacitance C=2400 uF, steady-state ripple voltage Vr=200 mV, n=3, and current I=4.7 A, the blanking period Tblkm becomes 73 uS when these values are put into the expression (5).

In this case, the blanking period Tblkm is about 0.43% of the time per frame when the frame rate is 60 Hz and is about 0.86% when the frame rate is 120 Hz.

That is, it is possible to curb generation of abnormal noise by setting the blanking period Tblkm to be less than a predetermined value on the basis of the impedance R and capacitance C of the MLCC 171 with respect to the time per frame by applying the above-described expression (5).

More specifically, a force that causes distortion in the MLCC 171 (a force that vibrates the board 153) F is generally represented by the following expression (6).

$$F = d \cdot Δ V ( N : Newton ) \qquad ( 6 )$$

Here, d is a piezoelectric strain constant that is a constant that each MLCC 171 has, and ΔV is the strength of the applied electric field, that is, the ripple voltage ΔV.

As described above, the force F that causes distortion in the MLCC 171 vibrates the board 153, thereby generating abnormal noise. In acoustic engineering, the radiation power W(w) of the generated abnormal noise satisfies the relationship represented by the following expression (7) on the basis of the area of the board 153, the vibration velocity of the board 153, the density of the board 153 serving as a medium, and the propagation velocity of sound.

$$W ∝ S \cdot {( Δ v average )}^{2} \cdot ρ c ( w : Watts ) \qquad ( 7 )$$

Here, S is the area of the board 153, Δv average is the vibration velocity of the board 153, ρ is the density of the board 153 serving as a medium, and c is the propagation velocity of sound.

Further, since the vibration velocity Δv average of the board 153 is proportional to the force F that causes distortion in the MLCC 171 (the force that vibrates the board 153), the relationship of the following equation (8) is satisfied.

$$Δ v average ∝ F \qquad ( 8 )$$

Here, in Newtonian mechanics, the force that causes distortion in the MLCC 171 (the force that vibrates the board 153) F is represented as the product of mass and acceleration (F=m·a (m: mass, a: acceleration)), and thus the acceleration a also increases as the force F that causes distortion in the MLCC 171 (the force that vibrates the board 153) increases. As a result, the following relationship (9) is established.

$$W ∝ S \cdot {( F average )}^{2} \cdot ρ c = S \cdot {( d \cdot Δ V average )}^{2} \cdot ρ c ( w : Watt ) \qquad ( 9 )$$

In this way, the radiation power W(w) of abnormal noise representing the loudness of sound is proportional to the square of the ripple voltage ΔV.

From the above, in a case in which n in the above-described expression (5) is set to 3, the voltage Vr that is the maximum value of the ripple voltage ΔV becomes ⅓ (=1/n:n=3), and accordingly, the radiation power W(w) of abnormal noise representing the loudness of sound becomes 1/9 (=(⅓)²).

That is, in the expression (5), by setting the blanking period such that n is set to 3 or more, the radiation power W(w) of abnormal noise representing the loudness of sound can be reduced to 1/9= 1/10 or less, and thus the human sense of hearing can be made to feel quieter.

However, since there is a control limit for Scanline switching times indicated by times t102 to t103 and t104 to t105 shown in the lowest part of FIG. 12, the blanking period Tblkm set using the expression (5) cannot be set to be shorter than the control limit related to the Scanline switching times.

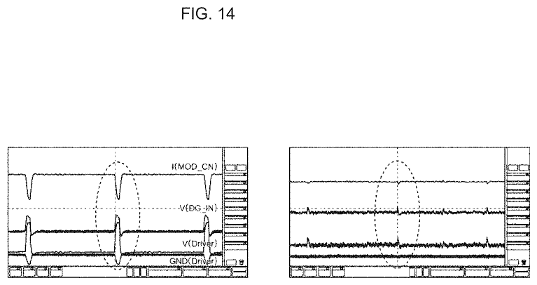

In a case in which the blanking period has a length according to the standard as in the past, a ripple voltage is generated as the current flowing through LEDs decreases during the blanking period, as shown by the portion surrounded by the dotted line in the left part of FIG. 14, for example.

On the other hand, by setting a short blanking period using the method of the present disclosure, a decrease in the current flowing through the LEDs is curbed, as shown by the waveform in the right part of FIG. 14, and accordingly, generation of the ripple voltage is curbed.

As a result, distortion of the board 153 caused by expansion and contraction of the MLCC 171 is eliminated, and thus generation of abnormal noise is curbed.

FIG. 14 shows the waveforms of a current, a power supply input voltage, a voltage applied to the LED driver 121, and a ground potential from the top.

Further, in a case in which a plurality of display units 51 are mounted on the board 153, for example, it is conceivable that the operations of the plurality of display units 51 will be completely synchronized. According to synchronized operations of the plurality of display units 51 in this manner, it is possible to display a high-definition moving image with higher precision. Further, since it is possible to display a high-definition image with high precision, it is also possible to realize high-precision retakes.

Meanwhile, when the operations of the plurality of display units 51 are completely synchronized, a higher ripple voltage ΔV is generated due to the blanking period being set according to the conventional regulations, and accordingly, greater abnormal noise is generated.

However, even when the operations of the plurality of display units 51 are completely synchronized, generation of the ripple voltage ΔV can be curbed by shortening the blanking period to curb generation of the ripple voltage ΔV, as described above, and thus it is possible to curb generation of greater abnormal noise generated when a high-definition image is displayed s with high precision according to the technique of the present disclosure.

Although Scan lines 1 to N are displayed once for each frame in chronological order, and it is written that frames to be sequentially displayed as frames F1, F2, . . . proceed in FIG. 11, processing for sequentially displaying Scan lines 1 to N of the same frame is cyclically repeated a plurality of times in real processing. A video signal includes information specifying N, which is the number of cycles and the number of Scan lines, information on a blanking period defined by general standards, and the like, and the signal processing unit 112 takes the video information including such information and the board mounting information of the board 153 stored in the ROM 123 into consideration, and sets a blanking period shorter than the blanking period specified by general standards.

Further, although an example in which a configuration in which the LEDs 141 are arranged in the horizontal direction in units of rows is set as ScanLine, and an image is displayed on the entire LED display by causing the LEDs to sequentially emit light in units of rows (units of Scanlines) from top to bottom has been described above, the LEDs may be caused to sequentially emit light from bottom to top in units of rows (units of Scanlines).

Further, a configuration in which the LEDs 141 are arranged in the vertical direction in units of columns may be set as ScanLine, and an image may be displayed by causing the LEDs to sequentially emit light from right to left or from left to right in units of columns (units of Scanlines) in the horizontal direction. That is, the LEDs 141 constituting the ScanLine unit may be configured in units of rows arranged in the horizontal direction or may be configured in units of columns arranged in the vertical direction.

### 8. Display Processing

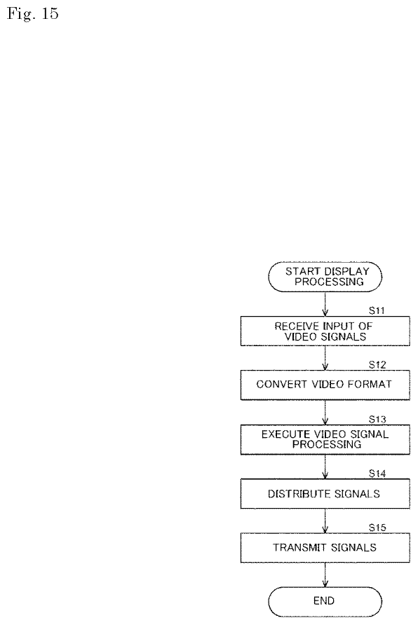

Next, display processing performed by the display system 11 in FIG. 1 will be described with reference to the flowchart of FIG. 15.

In step S11, the signal processing unit 78 receives input of video signals including content data and the like supplied from the video server 31 via any of the HDMI terminal 72, the DP terminal 73, and DVI terminal 74, and the signal input IF 77.

In step S12, the signal processing unit 78 converts the video format of the input video signals.

In step S13, the signal processing unit 78 receives input of a control signal supplied from the MPU 76 according to operation content of the PC 30, and executes signal processing regarding color temperature, contrast, brightness, and the like.

In step S14, the signal processing unit 78 allocates and distributes the video signals subjected to signal processing to the display units 51-1 to 51-n of the video wall 33.

In step S15, the signal processing unit 78 transmits and outputs the distributed video signals to each of the corresponding display units 51-1 to 51-n.

Through the series of processing described above, since the video signals read out from the video server 31 are subjected to signal processing and distributed and transmitted to each of the display units 51-1 to 51-n constituting the video wall 33, and thus the individual videos are displayed by the display units 51-1 to 51-n, the video wall 33 can display the video of video content as a whole.

### 9. Driver Control Processing by Display Unit

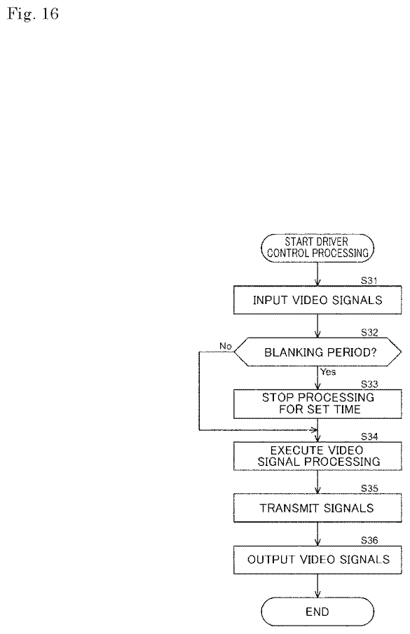

Next, driver control processing performed by the display unit 51 will be described with reference to the flowchart of FIG. 16.

In step S31, the signal processing unit 112 in the driver controller 91 of the display unit 51 receives input of video signals distributed and supplied from the video wall controller 32 in units of rows via the signal input IF 111.

In step S32, the signal processing unit 112 determines whether or not a period is a blanking period. That is, the signal processing unit 112 determines whether or not it is a timing to enter a blanking period on the basis of whether the video signals in units of rows received via the signal input IF 111 are video signals of the top row of the top of a new frame.

If it is determined that the period is a blanking period in step S32, processing proceeds to step S33.

In step S33, the signal processing unit 112 stops processing for a time set as the length of the blanking period. However, the length of the blanking period set here is a length by which a rise of the ripple voltage ΔV described above can be curbed and generation of abnormal noise caused by distortion of the board 153 involving expansion and contraction of the MLCC 171 can be curbed. That is, the length of the blanking period set here is shorter than the length of the blanking period included in a video signal that is an input signal received via the signal input IF 111, that is, the blanking period defined by general standards.

If it is determined that the period is not a blanking period in step S32, processing of step S33 is skipped.

In step S34, the signal processing unit 112 executes video signal processing for performing color and luminance correction corresponding to each display unit 51 on the video signals in units of rows distributed as the display unit 51.

In step S35, the signal processing unit 112 allocates the video signals in units of rows subjected to video signal processing to the LED drivers 121-1 to 121-N in the LED block 92, and transmits the video signals through the corresponding output IFs 114-1 to 114-N.

In step S36, the LED drivers 121-1 to 121-N in the LED block 92 execute LED drive control processing on the basis of the video signals in units of rows, and displays a video in units of rows with appropriate luminance in the LED arrays 122-1 to 122-N according to PWM control.

Through the above processing, appropriate luminance adjustment is performed in each of the display units 51 constituting the video wall 33, and the video signals are output to the LED block 92, and thus a video can be displayed in units of sequential rows.

At this time, in a case in which the input video signal corresponds to the first row of a new frame, processing is stopped for a blanking period set by the above-described expression (5) to be shorter than the length of the blanking period defined by the conventional standards.

Accordingly, the time in which LEDs are turned off during the blanking period is shortened compared to the blanking period defined by the conventional standards, and thus it is possible to curb generation of the ripple voltage ΔV.

As a result, since application of the ripple voltage ΔV to the MLCC 171 is curbed, occurrence of distortion in the boards 152 and 153 due to expansion and contraction of the MLCC 171 caused by application of the ripple voltage ΔV to the MLCC 171 is curbed, which makes it possible to curb generation of abnormal noise.

Furthermore, since the blanking time using the above-described expression (5) is set in proportion to the capacitance C of the MLCC 171, the blanking time can be shortened by reducing the capacitance of the MLCC 171. Accordingly, it is possible to curb generation of abnormal noise and further reduce costs.

### 10. First Application Example

An example in which generation of the ripple voltage ΔV and generation of abnormal noise are curbed by shortening the time during which LEDs are turned off in the blanking period compared to the blanking period defined by conventional standards has been described above.

Incidentally, scanning in units of scan lines is repeated a plurality of times in one frame, but even at the time of returning from the last scan line to the first scan line, there is a short blanking period compared to the blanking period described above.

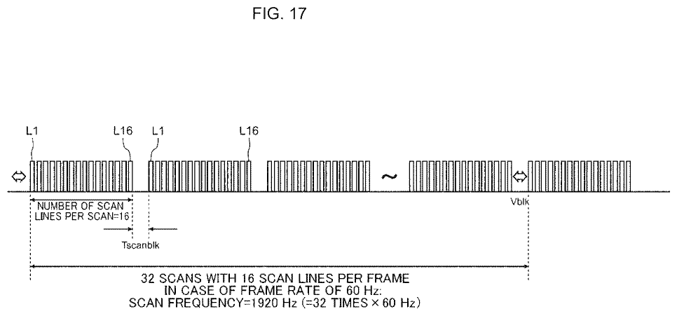

That is, in a case in which there are 16 scan lines consisting of scan lines L1 to L16, and they are repeated 32 times in one frame, scanning in units of scan lines L1 to L16 is repeated 32 times, as shown in FIG. 17.

At this time, even at the time of changing to the scan line L1 in order to proceed to the next scan from the scan line L16, a blanking period indicated by Tscanblk in FIG. 17 occurs.

Hereinafter, a blanking period that occurs at the time of returning from the last scan line to the first scan line in each scan in units of scan lines will be referred to as a scan blanking period Tscanblk.

Accordingly, the ripple voltage ΔV is also generated during this scan blanking period Tscanblk.

Therefore, generation of the ripple voltage ΔV and generation of abnormal noise may be curbed by shortening this scan blanking period Tscanblk in the same way as the above-mentioned blanking period.

In this case, the signal processing unit 112 determines whether or not the period is a blanking period or a scan blanking period. Then, when it is a time to enter a blanking period or a scan blanking period, processing is stopped for a time set as the length of the blanking period.

### 11. Driver Control Processing by Display Unit in First Application Example

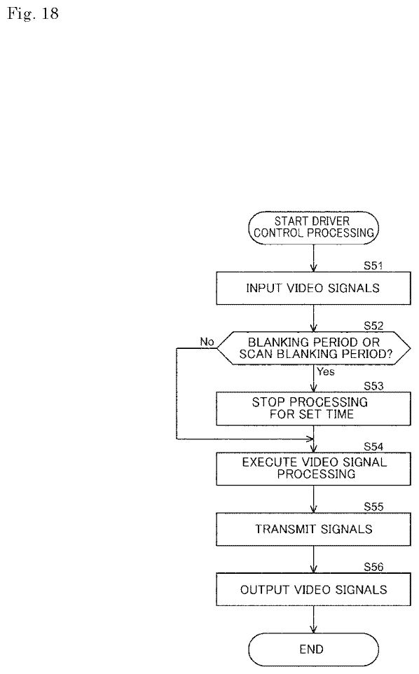

Next, driver control processing performed by the display unit 51 in the first application example will be described with reference to the flowchart of FIG. 18. Processing of steps S51 and S53 to S56 in FIG. 18 is the same as processing of steps S31 and S33 to S36 in FIG. 16, and thus description thereof will be omitted.

In step S51, input of video signals distributed and supplied from the video wall controller 32 is received via the signal input IF 111 in units of rows.

In step S52, the signal processing unit 112 determines whether or not a period is a blanking period or a scan blanking period.

If it is determined that the period is a blanking period or a scan blanking period in step S52, processing proceeds to step S53.

In step S53, the signal processing unit 112 stops processing for a time set as the length of the blanking period.

If it is determined that the period is not a blanking period or a scan blanking period in step S52, processing of step S53 is skipped.

Then, in steps S54 to S56, video signal processing for performing color and luminance correction, and the like corresponding to each of the display units 51 is executed on the distributed video signals in units of rows, the video signals are allocated and transmitted to the LED drivers 121-1 to 121-N in the LED block 92, LED drive control processing is executed on the basis of the video signals in units of rows, and a video is displayed in units of rows with an appropriate luminance through PWM control.

According to the above processing, in either a blanking period or a scan blanking period, processing is stopped for a time set using the above-described expression (5) to be shorter than the length of the blanking period defined by the conventional standards.

Accordingly, since the time during which LEDs are turned off during the blanking period and the scan blanking period is shortened compared to the blanking period defined by the conventional standards, it is possible to curb generation of the ripple voltage ΔV.

As a result, application of the ripple voltage ΔV to the MLCC 171 is curbed, and thus distortion of the boards 152 and 153 caused by expansion and contraction of the MLCC 171 due to application of the ripple voltage ΔV to the MLCC 171 is curbed, which prevents generation of abnormal noise.

### 12. Second Application Example

An example in which generation of the ripple voltage ΔV is curbed to prevent generation of abnormal noise by shortening the time during which LEDs are turned off during the scan blanking period in addition to the blanking period compared to the blanking period defined by the conventional standards has been described above.

However, by setting the scan frequency high together with the frame rate to make generated abnormal noise out of an audible band, even if abnormal noise is generated, it may be difficult for humans to recognize it as abnormal noise.

As described with reference to FIG. 17, in a case in which the frame rate is 60 Hz and 32 scans are performed per frame, the scan frequency, which is the number of scans per second, is 1920 Hz (=32×60). Further, in this case, the ripple voltage ΔV is generated 1920 times per second, and thus abnormal noise having a frequency of 1920 Hz (=32×60) is generated.

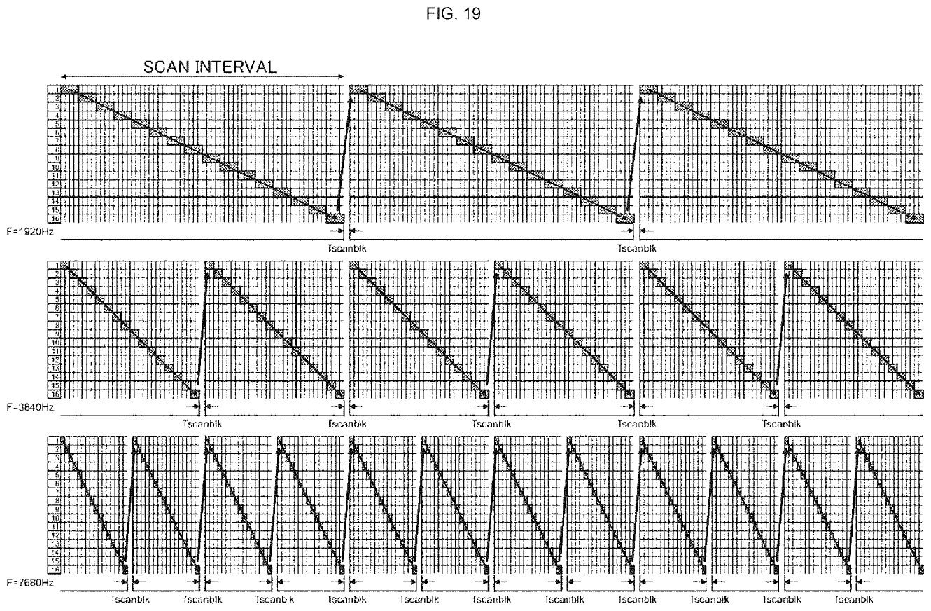

For example, in a case in which the frame rate is 60 Hz, a scan state when 32 scans are performs is represented as shown in the uppermost part of FIG. 19.

In the uppermost part of FIG. 19, scan lines L1 to L16 (represented by numbers 1 to 16 in the left column in the figure) from the first row to the sixteenth row from the top in the figure are set, scanning is performed at timing marked with a grid pattern with respect to the time direction represented in the right direction in the figure, and every time 16 rows are scanned, the scan blanking period Tscanblk, that is, the ripple voltage ΔV′ is generated. The ripple voltage ΔV′ in the scan blanking period Tscanblk is not the same as the ripple voltage ΔV in the blanking period described above, but is similar and is substantially the same voltage, and thus it is marked with “′”.

However, in order to make it easier to visually ascertain the timing of scanning and blanking periods related to the 32 scan lines, FIG. 19 represents 16 scan lines, and it is assumed that generated abnormal noise is 1920 Hz on the basis of the timing chart shown in the uppermost part of FIG. 19.

Hereinafter, the number of times per second the ripple voltage ΔV, which causes abnormal noise, is generated during the scan blanking period Tscanblk is also referred to as a ripple frequency.

For example, in a case in which the scan frequency of 1920 Hz is doubled to 3840 Hz, as shown in the middle part of FIG. 19, the scan blanking period Tscanblk, that is, the number of generations of the ripple voltage ΔV′, becomes twice the case shown in the uppermost part of FIG. 19. Therefore, in this case, the ripple frequency is 3840 Hz, and abnormal noise having a higher frequency is generated.

Furthermore, in a case in which the scan frequency of 1920 Hz is quadrupled to 7680 Hz, for example, as shown in the middle part of FIG. 19, the scan blanking period Tscanblk, that is, the number of generations of the ripple voltage ΔV′, becomes four times the case shown in the uppermost part of FIG. 19. Therefore, in this case, the ripple frequency is 7680 Hz, and abnormal noise having a higher frequency is generated.

Since abnormal noise is also generated in each scan, by increasing the scan frequency in this manner such that the time for one scan for each scan line is shortened, the radiation power of the abnormal noise is reduced, and thus the effect of reducing the abnormal noise is produced.

However, the human audible band includes a range of 1920 Hz to 7680 Hz, and thus the control described with reference to FIG. 19 causes generation of abnormal noise in the audible band.

For this reason, it is conceivable to generate abnormal noise exceeding 10 kHz, which is close to the upper limit of the audible band, by further increasing the scan frequency to increase the ripple frequency.

That is, if the scan frequency of 1920 Hz is increased by eight times, for example, it becomes abnormal noise exceeding 10 kHz, that is, abnormal noise in the audible band but in a region with reduced hearing sensitivity, which is difficult to be perceived by human hearing, and thus it is not recognized as abnormal noise and therefore it is possible to substantially curb the abnormal noise.

However, the scan frequency has a limit that can be realized by hardware, such as a pulse width modulation (PWM) control limit in the LED driver 121 and operation limits of other ICs, and it is possible to quadruple the scan frequency, but since the configuration is costly, it is not realistic to control the ripple frequency to exceed 3840 Hz in order to suppress abnormal noise with an inexpensive configuration.

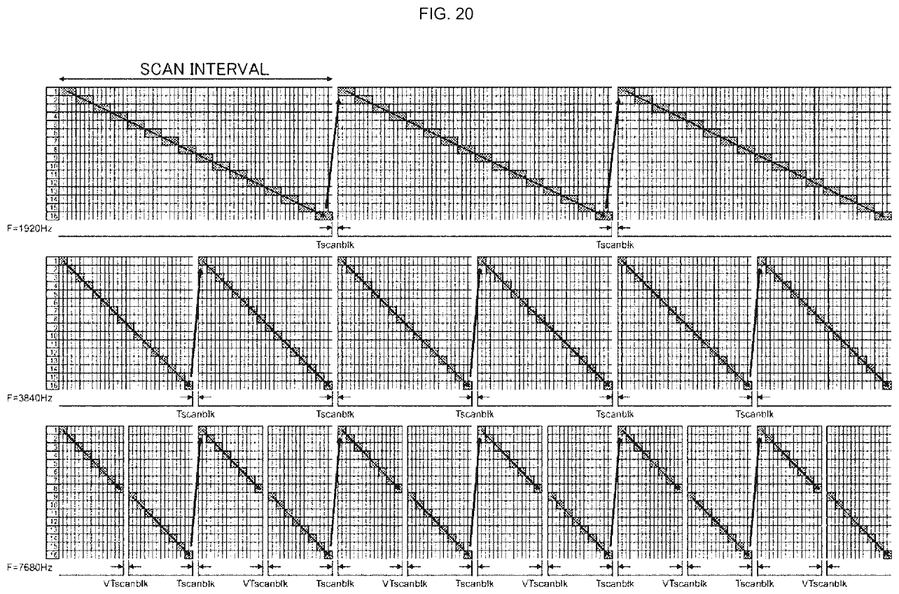

Therefore, in the present disclosure, as shown in FIG. 20, a virtual blanking period is set in the scan interval of one frame, and only the ripple frequency is increased without increasing the scan frequency, thereby reducing the burden on hardware and making abnormal noise difficult for humans to perceive, realizing substantial suppress of abnormal noise.

In FIG. 20, the uppermost and middle parts are the same as those in FIG. 19. In the lowermost part of FIG. 20, the scan frequency of 1920 Hz is set to about twice that which can be realistically controlled, and one virtual scan blanking period (hereinafter referred to as virtual scan blanking period) VTscanblk is set for each scan interval.

That is, as shown in the lowermost part of FIG. 20, the virtual scan blanking period VTscanblk is set at the timing when scan of half of all scan lines ends during one scan, and thus the blanking period Tblk and the virtual scan blanking period VTscanblk are set at equal intervals.

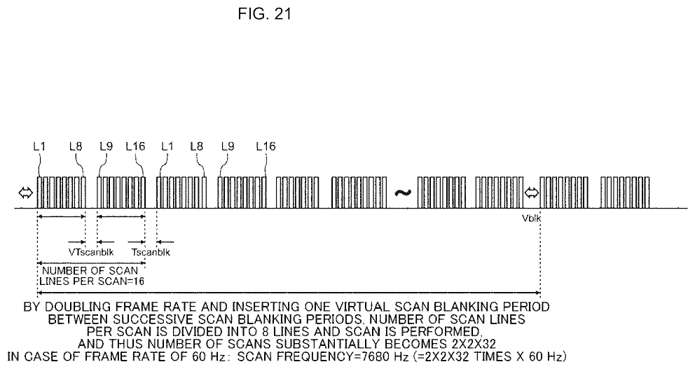

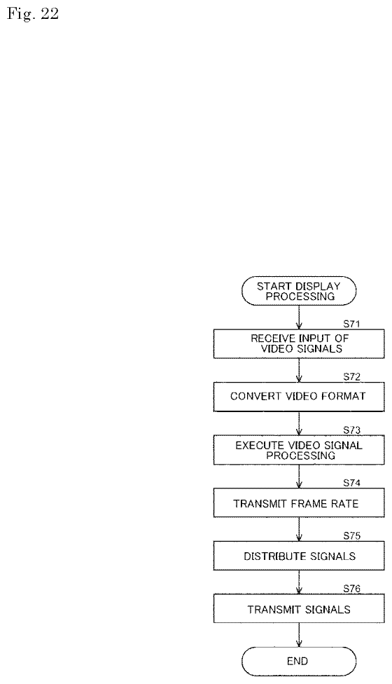

More specifically, the scan blanking period Tscanblk and the virtual scan blanking period VTvscanblk have a relationship as shown in FIG. 21.

That is, in a case in which scan lines L1 to L16 are scanned once, the virtual scan blanking period VTvscanblk is set at the timing when scan of scan lines L1 to L8 ends. Then, the blanking period Tblk is set at the time when scan of scan lines L9 to L16 ends.

This allows the ripple frequency to be substantially the same as the ripple frequency when the scan frequency is increased to eight times 1920 Hz. When the ripple frequency exceeds 7680 Hz, part of vibration is absorbed by the board 153 and the radiation power of abnormal noise is reduced, and thus the effect of reducing generation of abnormal noise is produced. Further, since the ripple frequency approaches 10 kHz, which is close to the upper limit of the audible band, it becomes difficult to be perceived as abnormal noise. In either case, it is possible to substantially reduce abnormal noise as a result. Furthermore, by adding the virtual scan blanking period VTscanblk and increasing the ripple frequency to 10 kHz or more, for example, it is possible to further enhance the effect of reducing abnormal noise.

Although an example in which the virtual scan blanking period VTscanblk is set at the timing when scan of half of all scan lines ends in one scan has been described in the lowermost part of FIG. 20, the virtual scan blanking period VTscanblk may be set longer than this if the blanking period and the virtual scan blanking period are set at equal intervals.

For example, in a case in which the total number of scan lines in one scan is 12 lines, two virtual scan blanking periods VTscanblk may be set at the timing when scan of the fourth line, which is the scan line of the first ⅓ scan lines, ends, and the timing when scan of the eighth line, which is the scan line of the next ⅓ scan lines, ends.

That is, as long as the scan blanking period Tscanblk and the virtual scan blanking period VTscanblk are set at equal intervals, a larger number of virtual scan blanking periods VTscanblk may be set.

In addition, in a case in which the virtual scan blanking period VTscanblk is set at the timing when scan of half of the scan lines ends, as shown in the lowermost part of FIG. 20, the ripple frequency becomes a frequency twice the frame rate.

Furthermore, as described above, in a case in which the number of scan lines for one scan is 12, the ripple frequency becomes three times the scan frequency when a total of two virtual scan blanking periods VTcanblk are set at the timing when scan of the fourth line, which is the scan line of the first ⅓ scan lines, ends and the timing when scan of the eighth line, which is the scan line of the next ⅓ scan line, ends.

Accordingly, the ripple frequency can be set to substantially multiple times ((n+1) times) the frame rate where n is the number of virtual scan blanking periods set in one frame.

However, the human audible band does not exist in a region of 20 kHz or higher, and if the virtual scan blanking period VTscanblk excessively increases, emission time becomes short and illuminance decreases.

Therefore, the virtual scan blanking period VTscanblk is set such that the ripple frequency set together with the blanking period Tblk and the scan blanking period Tscanblk is set in a range from a range that does not reach and is near the upper limit of the human audible band to a lower limit of a band (non-audible band) in which it is completely unperceivable as abnormal noise, and it is desirable to set the upper limit to a level exceeding 10 kHz, for example.

The reason why the range includes the vicinity of the upper limit of the audible band, which does not reach the upper limit of the human audible band, is that the simply approaching the upper limit of the audible band will make it less likely to be acoustically perceived as abnormal noise, and thus the effect of substantially reducing abnormal noise can be obtained while securing a turn-off time.

In addition, although the source of abnormal noise is bending of the board 153 caused by a change in the ripple voltage ΔV, as described above, the change in the ripple voltage ΔV depends on the luminance, and vibration of the board 153 is also affected by the material (hardness) of the board 153.

That is, since the current value and the voltage value that flow change according to the luminance, the ripple voltage ΔV changes according to the luminance as a result.

For this reason, the signal processing unit 112 in the driver controller 91 of the display unit 51 sets the virtual scan blanking period VTscanblk according to a frame rate supplied as a control signal from the video wall controller 32, the luminance in a video signal, and information on the material (hardness) of the board 153 stored in the DRAM 113 in advance.

For example, in a case in which the luminance is higher than a predetermined value, the ripple voltage ΔV increases, and thus the signal processing unit 112 may set a virtual scan blanking period such that the ripple frequency becomes higher than a predetermined value.

However, if the ripple frequency excessively increases, a turn-off period increases to cause illuminance decrease, as described above, for example, and thus the virtual scan blanking period may be set such that the ripple frequency reaches the above-described upper limit in a case in which the luminance is higher than the predetermined value. On the other hand, if the luminance is not higher than the predetermined value, the virtual scan blanking period may be set such that the ripple frequency is lower than the upper limit.

In addition, in the lowermost part of FIG. 20, a ripple frequency that is substantially four times the scan frequency in the uppermost part of FIG. 20 is realized by doubling the scan frequency in the uppermost part of FIG. 20 and then setting one virtual scan blanking period for each scan. However, a ripple frequency that is substantially four times the scan frequency in the uppermost part of FIG. 20 may be realized by setting three virtual scan blanking periods for each scan while keeping the scan frequency in the uppermost part of FIG. 20.

Although the burden on hardware related to PWM control is reduced by setting a virtual scan blanking period without multiplying the scan frequency to increase the ripple frequency, the scan time for each scan line decreases, and thus abnormal noise is likely to be generated and the effect of reducing abnormal noise is reduced compared to the case where the scan frequency is multiplied.

That is, at the time of setting a virtual scan blanking period to increase the ripple frequency, whether or not to perform processing after multiplying the scan frequency is a trade-off between the burden on hardware related to PWM control and a degree of effect related to abnormal noise reduction.

In the current technology, processing with a ripple frequency of 1920 Hz described with reference to the uppermost part of FIG. 20 is common, and doubling the scan frequency and increasing the ripple frequency to 3840 Hz is a low-cost technique that can be realized, and thus it can be said that processing up to the middle part of FIG. 20 is a technique that can be realized at a low cost.

However, in order to realize processing with a higher scan frequency, the cost of hardware related to PWM control increases. Therefore, in the current technology, for a configuration with a general ripple frequency of 1920 Hz, the method of doubling the scan frequency and then setting a virtual scan blanking period such that the ripple frequency becomes a multiple of the scan frequency to reduce abnormal noise can be said to be an excellent method in terms of the degree of abnormal noise reduction and cost performance.

The signal processing unit 112 stops processing during the scan blanking period Tscanblk and the virtual scan blanking period VTscanblk in the same way as in the blanking period Tblk.

The length of the scan blanking period Tscanblk and the virtual scan blanking period VTscanblk may be set similarly to the blanking period.

However, since processing described with reference to FIG. 20 is not processing for actually curbing generation of abnormal noise, if the virtual scan blanking period is set such that the ripple frequency becomes a multiple of the frequency of the scan blanking period, it will be difficult to recognize it as abnormal noise even if the length of the blanking period, scan blanking period, and virtual scan blanking period is the same as the conventional length, and thus it is possible to obtain the effect of substantially reducing abnormal noise.

However, similar to the length of the blanking period, by shortening the scan blanking period and the virtual scan blanking period, fluctuations in the ripple voltage ΔV can be reduced, and vibration can be suppressed to curb generation of abnormal noise itself, and thus the effect of reducing abnormal noise can be enhanced.

In addition, in the second application example, generation of abnormal noise itself is not curbed, and generated abnormal noise is made difficult to be perceived as abnormal noise. For this reason, for example, with respect to abnormal noise generated due to vibration of a board having an MLCC, wiring, and the like caused by the ripple voltage ΔV generated at a predetermined cycle in other devices such as LED backlights, by setting LED turn-off periods such as the blanking period, scan blanking period, and virtual scan blanking period such that the ripple frequency exceeds the audible band, it is possible to make it difficult to be perceived as abnormal noise.

### 13. Display Processing in Second Application Example

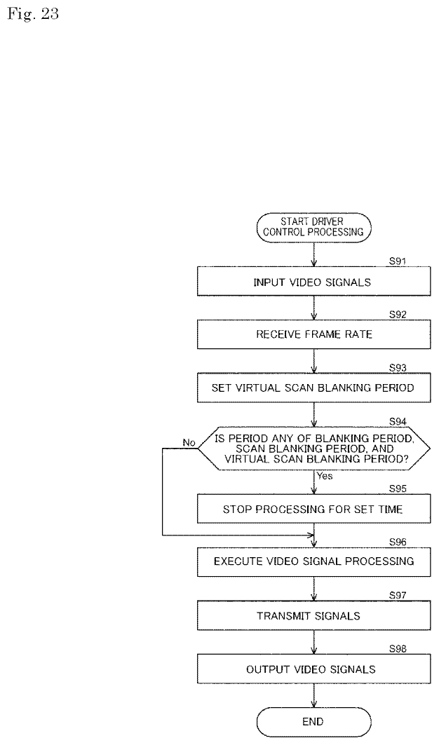

Next, display processing in the second application example performed by the display system 11 of FIG. 1 will be described with reference to the flowchart of FIG. 22. Processing of steps S71 to S73 and steps S75 and S76 in the flowchart of FIG. 22 is the same as processing of steps S11 to S13 and steps S15 and S16 in the flowchart of FIG. 15, and thus description thereof will be omitted.

That is, in steps S71 to S73, input of video signals is received, the video format is converted, input of a control signal supplied according to operation content of the PC 30 supplied from the MPU 76 is received, and signal processing with respect to color temperature, contrast, brightness, and the like is executed.

In step S74, the signal processing unit 78 supplies information on the frame rate of the video signals subjected to signal processing to the signal processing unit 112 in the driver controller 91 of the display unit 51 as a control signal.

Thereafter, in steps S75 and S76, the video signals subjected to signal processing are allocated, distributed, and transmitted to the display units 51-1 to 51-n of the video wall 33.

According to the aforementioned series of processing, video signals read from the video server 31 are subjected to signal processing, and distributed and transmitted to the display units 51-1 to 51-n constituting the video wall 33, and the frame rate is further supplied to the display unit 51.

Accordingly, individual videos are displayed by the display units 51-1 to 51-n, and thus the video wall 33 can display the video of video content as a whole. Furthermore, in each of the display units 51, it is possible to set the virtual scan blanking period VTscanblk on the basis of the frame rate, and it is possible to suppress abnormal noise.

### 14. Driver Control Processing by Display Unit in Second Application Example

Next, an application example of driver control processing performed by the display unit 51 will be described with reference to the flowchart of FIG. 23. Processing of steps S91 and S95 to S98 in FIG. 23 is the same as processing of steps S33 to S36 in the flowchart of FIG. 16, and thus will be omitted as appropriate.

That is, in step S91, input of video signals distributed and supplied from the video wall controller 32 is received via the signal input IF 111 in units of rows.

In step S92, the signal processing unit 112 receives information on a frame rate supplied as a control signal from the video wall controller 32.

In step S93, the signal processing unit 112 sets a virtual scan blanking period VTscanblk such that the ripple frequency is higher than a predetermined frequency that is difficult to be recognized as abnormal noise on the basis of luminance based on the video signals, information on the material (hardness) of the board 153 stored in advance in the DRAM 113, and information on the frame rate.

That is, the signal processing unit 112 sets a blanking period, a scan blanking period, and a virtual scan blanking period along with the length thereof such that a ripple frequency that is multiple times the frequency of the scan blanking period and is higher than a predetermined frequency that is difficult to be recognized as abnormal noise (higher than the audible band) is realized on the basis of the luminance based on the video signals, the information on the material (hardness) of the board 153, and the information on the frame rate.

In step S94, the signal processing unit 112 determines whether or not a period is a blanking period, a scan blanking period, or a virtual scan blanking period. That is, the signal processing unit 112 determines whether or not it is a timing to enter a blanking period and a timing to enter any of a scan blanking period and a virtual scan blanking period.

If it is determined that the period is any of a blanking period, a scan blanking period, and a virtual scan blanking period in step S94, processing proceeds to step S95.

In step S95, the signal processing unit 112 stops processing for a time set as the length of the blanking period, scan blanking period, and virtual scan blanking period.

If it is determined that the period is not any of a blanking period, a scan blanking period, and a virtual scan blanking period in step S94, processing of step S95 is skipped.

Then, in steps S96 to S98, video signal processing for performing color and luminance correction and the like corresponding to each of the display units 51 is executed, the video signals are allocated to the LED drivers 121-1 to 121-N in the LED block 92 and transmitted through the corresponding output IFs 114-1 to 114-N, LED drive control processing is executed on the basis of the video signals in units of rows, and a video is displayed in units of rows with appropriate luminance through PWM control.

Since processing is stopped during the blanking period, scan blanking period, and virtual scan blanking period that are set to a time shorter than the length of the blanking period defined by the conventional standards, a time for which LEDs are in a turn-off state decreases, and thus generation of the ripple voltage ΔV is curbed.

In addition, since it is possible to increase the ripple frequency without increasing the scan frequency by setting the virtual scan blanking period in addition to the blanking period and the scan blanking period, it is possible to make it difficult to recognize generated abnormal noise as abnormal noise by making the generated abnormal noise out of the audible band, and thus the abnormal noise can be substantially reduced.

Accordingly, it is possible to curb generation of abnormal noise by shortening the durations of the blanking period, scan blanking period, and virtual scan blanking period and it is possible to make it difficult to recognize generated abnormal noise as abnormal noise by setting the virtual scan blanking period to increase the ripple frequency without increasing the scan frequency.

As a result, it is possible to achieve the effect of suppressing abnormal noise at a low cost.

### 15. Example of Execution by Software

Incidentally, the series of processing described above can be executed by hardware, but can also be executed by software. In a case in which the series of processing is executed by software, programs constituting the software are installed from a recording medium to a computer built into dedicated hardware or a general-purpose computer that can execute various functions by installing various programs, for example.

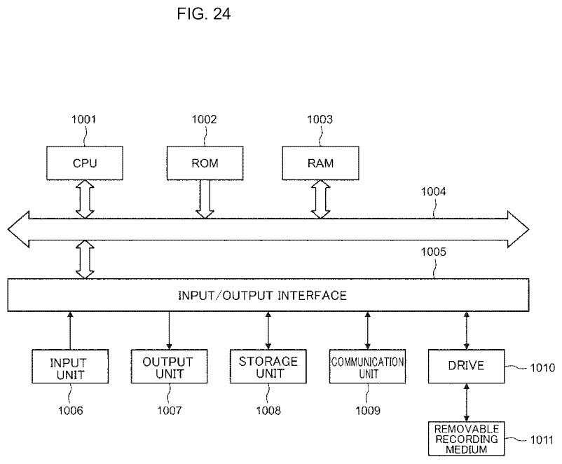

FIG. 24 shows a configuration example of a general-purpose computer. This computer has a built-in central processing unit (CPU) 1001. An input/output interface 1005 is connected to the CPU 1001 via a bus 1004. A read only memory (ROM) 1002 and a random access memory (RAM) 1003 are connected to the bus 1004.

An input unit 1006 including input devices such as a keyboard and a mouse through which a user inputs operation commands, an output unit 1007 that outputs processing operation screens and images of processing results to a display device, a storage unit 1008 including a hard disk drive and the like for storing programs and various types of data, and a communication unit 1009 including a local area network (LAN) adapter, and the like and executing communication processing through a network represented by the Internet are connected to the input/output interface 1005. In addition, a drive 1010 that reads/write data from/to a removable storage medium 1011 such as a magnetic disc (including a flexible disk), an optical disc (including a compact disc-read only memory (CD_ROM) and a digital versatile disc (DVD)), a magneto-optical disc (including a mini disc (MD)), or a semiconductor memory is connected.

The CPU 1001 executes various types of processing according to programs stored in the ROM 1002 or programs read from the removable storage medium 1011 such as a magnetic disc, an optical disc, a magneto-optical disk, or a semiconductor memory, installed in the storage unit 1008, and loaded from the storage unit 1008 to the RAM 1003. The RAM 1003 also appropriately stores data necessary for the CPU 1001 to execute various types of processing.

In the computer configured as described above, the CPU 1001 performs the series of processing described above by loading a program stored in the storage unit 1008 to the RAM 1003 through the input/output interface 1005 and the bus 1004 and executing the program, for example.

The program executed by the computer (CPU 1001) can be provided by being recorded on the removable storage medium 1011 as a package medium or the like, for example. In addition, the program can be provided via wired or wireless transmission media such as local area networks, the Internet, and digital satellite broadcast.

In the computer, a program can be installed in the storage unit 1008 via the input/output interface 1005 by setting the removable storage medium 1011 in the drive 1010. Further, a program can be received by the communication unit 1009 via a wired or wireless transmission medium and installed in the storage unit 1008. Other programs can be installed in the ROM 1002 or the storage unit 1008 in advance.

A program executed by the computer may be a program in which processing is performed in chronological order in accordance with the order described in this specification or may be a program in which processing is performed in parallel or at necessary timing such as when a call is made.

The CPU 1001 in FIG. 24 realizes the functions of the signal processing unit 112.

Further, in this specification, a system means a set of a plurality of components (devices, modules (parts), and the like), and it does not matter whether or not all the components are in the same housing. Therefore, a plurality of devices accommodated in separate housings and connected via a network and a single device in which a plurality of modules are accommodated in one housing are both systems.

Embodiments of the present disclosure are not limited to the embodiments described above, and various modifications are possible without departing from the gist of the present disclosure.

For example, the present disclosure can adopt a configuration of cloud computing in which one function is shared by a plurality of devices via a network and jointly processed.

In addition, each step described in the flowcharts above can be executed by a single device, or can be executed by a plurality of devices in a shared manner.

Further, in a case in which one step includes a plurality of types of processing, the plurality of types of processing included in the step can be executed by one device or executed by a plurality of devices in a shared manner.

The present disclosure can also be configured as follows.
<1> A drive control device comprising at least one processor to implement a light emission control unit configured to control raising a frequency of a period in which light emitting diodes (LEDs) of an LED array are turned off.
<2> The drive control device according to <1>, wherein the light emission control unit is configured to control the frequency of the period in which the LEDs are turned off to be higher than a frequency of a human audible band.
<3> The drive control device according to <1>, wherein the light emission control unit is configured to control light emission of the LEDs of the LED array using a passive matrix drive method that controls light emission in units of scan lines.
<4> The drive control device according to <2>, wherein the light emission control unit is configured to control, based on a frame rate of an input signal, the frequency of the period in which the LEDs are turned off to be higher than the frequency of the human audible band.
<5> The drive control device according to <4>, wherein the light emission control unit is configured to control the frequency of the period in which the LEDs are turned off to be a scan frequency that is higher than the frequency of the human audible band and is a multiple of the frame rate.
<6> The drive control device according to <5>, wherein the period in which the LEDs are turned off is a first period from display of the last row in a previous scan to display of the first row in the next scan and a second period set at equal intervals between the consecutive first periods.
<7> The drive control device according to <6>, wherein the light emission control unit is configured to control a length of the period in which the LEDs are turned off to be shorter than a time indicated by the input signal.
<8> The drive control device according to <7>, wherein the time indicated by the input signal corresponds to a blanking period of the input signal.
<9> The drive control device according to <7>, wherein the light emission control unit is configured to control the length of the period in which the LEDs are turned off such that a voltage applied to a capacitor provided on a board of the device is changed.
<10> The drive control device according to <9>, wherein the light emission control unit is configured to control the length of the period in which the LEDs are turned off such that the voltage applied to the capacitor becomes one-third or less.
<11> The drive control device according to <7>, wherein the light emission control unit is configured to control the length of the period in which the LEDs are turned off according to a capacitance or impedance of the capacitor provided on the board of the device.
<12> The drive control device according to <11>, wherein the capacitor is a multilayer ceramic capacitor (MLCC).
<13> The drive control device according to <12>, wherein the light emission control unit is configured to:
acquire information regarding the capacitor provided on the board of the device, and
control the length of the period in which the LEDs are turned off based on the acquired information regarding the capacitor.
<14> The drive control device according to <5>, wherein the light emission control unit is configured to control, based on the scan frequency and a hardness of the board of the device, the frequency of the period in which the LEDs are turned off to be higher than the frequency of the human audible band.
<15> The drive control device according to <14>, wherein the light emission control unit is configured to control, based on the scan frequency, the hardness of the board, and a luminance of the LEDs, the frequency of the period in which the LEDs are turned off to be higher than the frequency of the human audible band.
<16> The drive control device according to <15>, wherein the light emission control unit is configured to control the frequency of the period in which the LEDs are turned off to be higher as the luminance of the LEDs is higher.
<17> The drive control device according to <15>, wherein the light emission control unit is configured to control the frequency of the period in which the LEDs are turned off to be near an upper limit of the human audible band and lower than a lower limit of a human inaudible band.
<18> The drive control device according to <5>, wherein the light emission control unit is configured to:
multiply the scan frequency, and
control the frequency of the period in which the LEDs are turned off to be higher than the frequency of the human audible band.
<19> A program causing a computer to function as a light emission control unit configured to control raising a frequency of a period in which light emitting diodes (LEDs) of an LED array are turned off.
<20> A display system including: a display part including a display having light emitting diodes (LEDs) disposed in the form of an array and a drive control device configured to control driving of the LEDs; and
a distribution device configured to:
receive input of video signals,
perform predetermined signal processing on the video signals, and
distribute the video signals to the display,
wherein the drive control device includes at least one processor to implement a light emission control unit configured to control raising a frequency of a period in which the LEDs are turned off.

### REFERENCE SIGNS LIST

11 Display system
30 PC
31 Video server
32 Video wall controller
33 Video wall
51, 51-1 to 51-n Display unit
78 Signal processing unit
91 Driver controller
92 Driver block
112 Signal processing unit
121, 121-1 to 121-N Drive circuit
122 Pixel array
151 AC power supply device
152, 153 Board/wiring
161, 162 wire
171 MLCC
172 Connecting part

1. A drive control device comprising at least one processor to implement a light emission control unit configured to control raising a frequency of a period in which light emitting diodes (LEDs) of an LED array are turned off.

2. The drive control device according to claim 1, wherein the light emission control unit is configured to control the frequency of the period in which the LEDs are turned off to be higher than a frequency of a human audible band.

3. The drive control device according to claim 1, wherein the light emission control unit is configured to control light emission of the LEDs of the LED array using a passive matrix drive method that controls light emission in units of scan lines.

4. The drive control device according to claim 2, wherein the light emission control unit is configured to control, based on a frame rate of an input signal, the frequency of the period in which the LEDs are turned off to be higher than the frequency of the human audible band.

5. The drive control device according to claim 4, wherein the light emission control unit is configured to control the frequency of the period in which the LEDs are turned off to be a scan frequency that is higher than the frequency of the human audible band and is a multiple of the frame rate.

6. The drive control device according to claim 5, wherein the period in which the LEDs are turned off is a first period from display of the last row in a previous scan to display of the first row in the next scan and a second period set at equal intervals between the consecutive first periods.

7. The drive control device according to claim 6, wherein the light emission control unit is configured to control a length of the period in which the LEDs are turned off to be shorter than a time indicated by the input signal.

8. The drive control device according to claim 7, wherein the time indicated by the input signal corresponds to a blanking period of the input signal.

9. The drive control device according to claim 7, wherein the light emission control unit is configured to control the length of the period in which the LEDs are turned off such that a voltage applied to a capacitor provided on a board of the device is changed.

10. The drive control device according to claim 9, wherein the light emission control unit is configured to control the length of the period in which the LEDs are turned off such that the voltage applied to the capacitor becomes one-third or less.

11. The drive control device according to claim 7, wherein the light emission control unit is configured to control the length of the period in which the LEDs are turned off according to a capacitance or impedance of the capacitor provided on the board of the device.

12. The drive control device according to claim 11, wherein the capacitor is a multilayer ceramic capacitor (MLCC).

13. The drive control device according to claim 12, wherein the light emission control unit is configured to:
acquire information regarding the capacitor provided on the board of the device, and
control the length of the period in which the LEDs are turned off based on the acquired information regarding the capacitor.

14. The drive control device according to claim 5, wherein the light emission control unit is configured to control, based on the scan frequency and a hardness of the board of the device, the frequency of the period in which the LEDs are turned off to be higher than the frequency of the human audible band.

15. The drive control device according to claim 14, wherein the light emission control unit is configured to control, based on the scan frequency, the hardness of the board, and a luminance of the LEDs, the frequency of the period in which the LEDs are turned off to be higher than the frequency of the human audible band.

16. The drive control device according to claim 15, wherein the light emission control unit is configured to control the frequency of the period in which the LEDs are turned off to be higher as the luminance of the LEDs is higher.

17. The drive control device according to claim 15, wherein the light emission control unit is configured to control the frequency of the period in which the LEDs are turned off to be near an upper limit of the human audible band and lower than a lower limit of a human inaudible band.

18. The drive control device according to claim 5, wherein the light emission control unit is configured to:
multiply the scan frequency, and
control the frequency of the period in which the LEDs are turned off to be higher than the frequency of the human audible band.

19. A program causing a computer to function as a light emission control unit configured to control raising a frequency of a period in which light emitting diodes (LEDs) of an LED array are turned off.

20. A display system comprising:
a display part including a display having light emitting diodes (LEDs) disposed in the form of an array and a drive control device configured to control driving of the LEDs; and
a distribution device configured to:
receive input of video signals,
perform predetermined signal processing on the video signals, and
distribute the video signals to the display,
wherein the drive control device includes at least one processor to implement a light emission control unit configured to control raising a frequency of a period in which the LEDs are turned off.
